(19) United States
(12) Patent Application Publication
(10) Pub. No.: US 2003/0101159 A1
(43) Pub. Date: May 29, 2003

(54) Personal information website system

(76) Inventors: Kenneth Liou, Taipei Hsien (TW); Ho-Yeh Yu, Taipei Hsien (TW)

Correspondence Address: RABIN & BERDO, P.C., Suite 500, 1101 14th Street, N.W., Washington, DC, 20005, US

(21) Appl. No.: 09/994,801

(22) Filed: Nov. 28, 2001

(51) Int. Cl. G06F 7/00

(52) U.S. Cl. 707/1

(57) ABSTRACT

A personal information website system comprises at least a data processing center, a plurality of electronic network name cards and a barcode transmitter; the data processing center stores a great amount of personal or organizational website address codes and service information; the electronic network name cards are printed with the website address barcodes; the barcode scan input device of the barcode transmitter is used to read the barcode on the name card and to convert it into a website address so as to quickly get on-line through a mobile phone or a computer for inquiring the data and the service items of the said website or storing the said read barcode data in a memory of the barcode transmitter for a long term; accordingly, the efficiency of being able to get on-line quickly, light and easy for carrying is thereby achieved.

### BACKGROUND OF THE INVENTION

1) Field of the Invention

The present invention relates to a personal information website system, more specifically, a network name card system permitting quick on-line through a network name card and a barcode transmitter as well as utilizing network service as a data bank to share huge sources so as to facilitate the engagement of Internet commercial service and information inquiry.

2) Description of the Prior Art

Accordingly, the arrival of the e-era of the Internet has shortened the distance among people, expanded people's perspective, accelerated the understanding among the countries and intermingled the world more; that is a tremendous advance in the history of the civilization of human technology.

The current network name card system of the prior art prints all the data contents of a 2D barcode on a name card, then a 2D barcode scanner directly reads the barcode data on the name cared for reading the data recorded on the said name card; however, the shortcoming of the said 2D barcode scanner is that the cost is more expansive and the cost of the machine for printing the 2D barcode is also higher; in addition, since all the data is printed on the barcode on the name card, the recoded content is limited and is bound to a fixed location for application (the 2D barcode scanner is not portable), therefore, it fails to achieve the economic value of commercial utilization.

In view of the shortcoming and inconvenience in actual application of utilizing a network name card of the prior art, the inventor of the invention, researched discreetly and based on the experience gained from engaging in the manufacturing and design of the said electronic business for many years, finally culminated an innovative personal information website system.

### SUMMARY OF THE INVENTION

The primary objective of the present invention is to provide a personal information website system for utilizing a portable barcode transmitter to get on-line according to the website address stored or on the name card for inquiring data or other service items as a personal name card book.

Another objective of the present invention is to provide a personal information website system for utilizing a huge amount of personal or organizational website address and data stored in a website data processing center so as to facilitate the others to inquiry on-line or provide information service.

For achieving the above objectives, the personal information website system of the present invention mainly comprises at least a data processing center, a plurality of electronic network name cards and a barcode transmitter; the data processing center stores a great amount of personal or organizational website address codes and service information; the electronic network name cards are printed with the website address barcodes; the barcode scan input device of the barcode transmitter is used to read the barcode on the name card and to convert it into a website address so as to quickly get on-line through a mobile phone or a computer for inquiring the data and the service items of the said website or storing the said read barcode data in a memory of the barcode transmitter for a long term.

The said barcode transmitter has a barcode scan input device capable of reading and storing the barcoded website address in the memory after a code is set by a press key; the said barcode transmitter has a mobile phone output interface or/and an USB output interface for quickly getting on-line after being connected through a mobile phone or a computer; or the USB output interface directly downloads the data of the website address edited by a computer into a memory for storage; or, the data of the website address can be transmitted back to the computer for conducting editing or filing.

In order to enable a further understanding of the structure, the device and the features of the present invention, the brief description of the drawings below is followed by the detailed description of the preferred embodiment.

### BRIEF DESCRIPTION OF THE DRAWINGS

FIG. 1 is a block diagram of the entire system of the present invention.

FIG. 2 is a block diagram of the circuit of a barcode transmitter of the present invention.

### DETAILED DESCRIPTION OF THE PREFERRED EMBODIMENTS

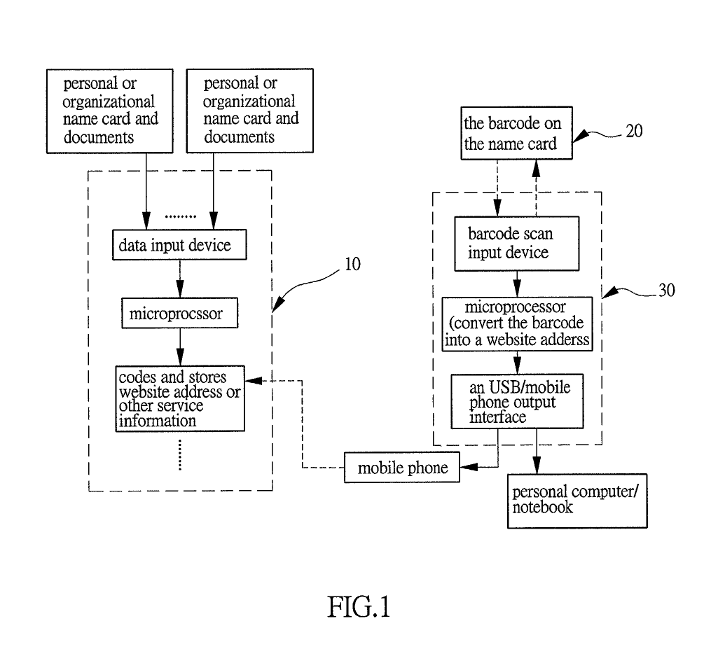

Referring to FIG. 1, the present invention of a personal information website system comprises at least a data processing center (10), a plurality of electronic network name cards (20) and a barcode transmitter (30); the data processing center (10) stores a great amount of detail data of personal or organizational website addresses and service items; the electronic network name cards (20) are printed with the website address barcodes; the barcode transmitter (30) is used to read the barcode on the name card (20) and to convert it into a website address so as to quickly get on-line through a mobile phone or a computer for inquiring the data and the service items of the said website or storing the said read barcode data in a memory of the barcode transmitter for a long term.

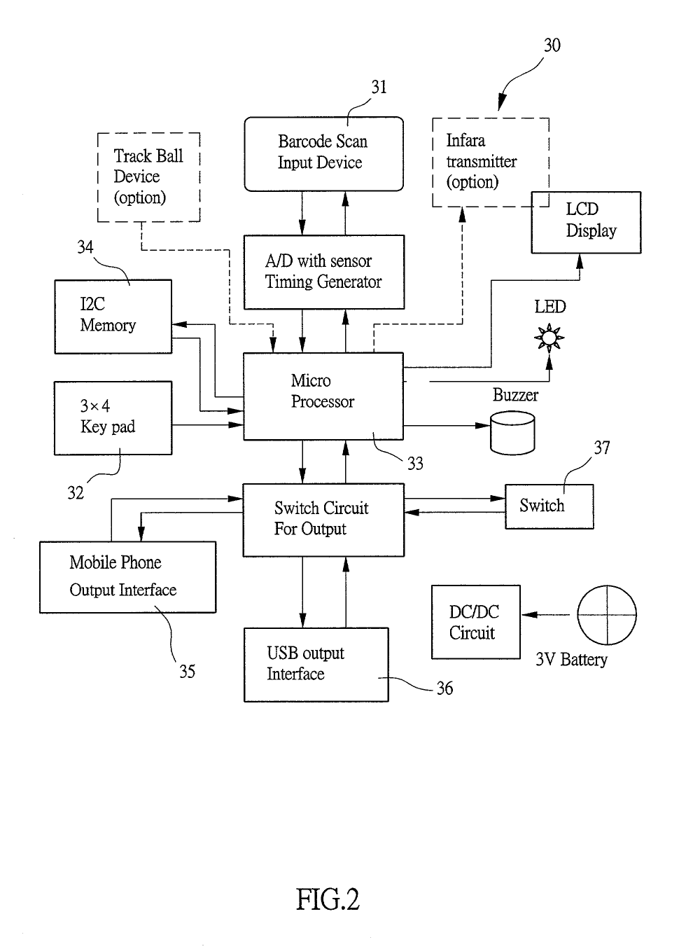

The said barcode transmitter (30), referring also to FIG. 2, has a barcode scan input device (31) capable of reading the barcoded website address on the name card, after the press key (32) sets a code, and storing the data in the memory (34) through a microprocessor (33); the said barcode transmitter (30) has a mobile phone output interface (35) or/and an USB output interface (36); a switch (37) selects a mobile phone output interface (35) or an USB output interface (36) to connect with a mobile phone or a computer (PC, Notebook computer, PDA or Cable TV) for quick on-line; or the USB output interface (36) directly downloads the data of the website address edited by a computer to a memory (34) for storage; or, the data of the website address in the memory (34) can be transmitted back to the computer for conducting editing or filing.

Accordingly, the present invention can be used as an electronic name card book to scan and memorize the ID on the network barcode electronic name card (20) for selecting the memory code of a person or a company, or to directly scan the barcode on the name card (20) to enter the said website to view the related files so as to benefit the development and business of the electronic commerce; people no longer needs to worry about how to file or carry the name cards.

In summation of the foregoing sections, the present invention of personal information website system is capable of specifically achieving the predict efficiency and objectives by having a huge data bank, being convenient and quick in serving people inquiring on-line; more especially, to cooperate the application by using a mobile phone can further extend the economic value and facilitation thereo.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A personal information website system comprises at least a data processing center, a plurality of electronic network name cards and a barcode transmitter; the data processing center stores a great amount of personal or organizational website address codes and service information; the electronic network name cards are printed with the website address barcodes; the barcode scan input device of the barcode transmitter is used to read the barcode on the name card and to convert it into a website address so as to quickly get on-line through a mobile phone or a computer for inquiring the data and the service items of the said website or storing the said read barcode data in a memory of the barcode transmitter for a long term.

2. A personal information website system according to claim 1, wherein the said barcode transmitter has a barcode scan input device capable of reading and storing the barcoded website address in the memory after a code is set by a press key; the said barcode transmitter has a mobile phone output interface or/and an USB output interface for quickly getting on-line after being connected through a mobile phone or a computer; or the USB output interface directly downloads the data of the website address edited by a computer to a memory for storage; or, the data of the website address can be transmitted back to the computer for conducting editing or filing.
